(19) United States
(12) Patent Application Publication
(10) Pub. No.: US 2012/0236701 A1
(43) Pub. Date: Sep. 20, 2012

(54) OBJECTIVE LENS FOR A COMBINATION THREE WAVELENGTH DISC DRIVE INCLUDING A BLU-RAY DISC READER AND A DVD/CD READER/WRITER, OPTICAL PICKUP INCORPORATING SAID OBJECTIVE LENS, AND A DISC DRIVE INCORPORATING SAID OPTICAL PICKUP

(75) Inventor: Yosuke Mizuyama, Newton, MA (US)

(73) Assignee: PANASONIC CORPORATION, Osaka (JP)

(21) Appl. No.: 13/047,613

(22) Filed: Mar. 14, 2011

(51) Int. Cl. G11B 7/135

(52) U.S. Cl. 369/112.06; G9B/7.112

(57) ABSTRACT

An objective lens for a slim type BD combo disc drive focuses a first light beam onto a first optical disc, a second light beam onto a second optical disc, and a third light beam having a third wavelength onto a third optical disc. The lens may include a first surface through which the first, second, and third light beams emitted from a light source enter the objective lens, and a second surface through which the first, second, and third light beams exit the objective lens and proceed toward the three corresponding optical discs. The first surface may include a diffractive surface which provides focus control in accordance with (i) 0th order light of the first and second light beams which are respectively focused onto the first and second optical discs, and (ii) 1st order diffracted light of the third light beam which is focused onto the third optical disc.

### FIELD OF THE INVENTION

This invention relates to optical drives for blu-ray discs (BD), digital versatile discs (DVD), and compact discs (CD). More particularly, the invention relates to a combination drive including a BD reader and a DVD/CD reader/writer. The invention further relates to an objective lens and an optical pickup for use in such optical drives.

### BACKGROUND OF THE RELATED ART

Conventionally, disc drives and optical pickups for blu-ray discs (BD), DVDs and CDs have employed two separate objective lenses, one for BD and another for DVD/CD. A significant problem with this type of arrangement is size. As the industry demands smaller and smaller size, a need has arisen for an effective and efficient single objective lens compatible with BD/DVD/CD.

Some prior art developed for a DVD/CD compatible objective lens addressed the problem of a large focus position difference. For example, a so-called dual focus objective lens provided a diffractive surface on at least one side of the lens. This lens made use of 0th order (non-diffracted) light for DVD and 1st order diffracted light for CD. Another example disclosed by U.S. Pat. No. 5,737,295 provided a DVD and CD compatible lens using +1st order and −1st order diffracted lights respectively for DVD and CD.

However, these prior art lenses suffered from low diffraction efficiencies for the light beams used to record and reproduce data to and from the CDs and DVDs, because one single beam was split into two beams, which resulted in 40% efficiency in the best case. Furthermore, these methods were not developed to be compatible with BD.

Development of a single objective lens compatible with BD/DVD/CD for a thick type optical disc drive involves a relatively easy lens configuration because it requires compensation of a large spherical aberration created by different wavelengths. A staircase lens has been used for that purpose. For thick type drives, BD/DVD/CD objective lenses may be configured to have approximately the same focal length for all BD/DVD/CD wavelengths, even though this results in a large lens thickness and size. This large lens thickness and size is not a problem for thick type optical disc drives.

An example of a single objective lens compatible with BD/DVD/CD for a thick type optical drive is shown in FIG. 1. As shown in FIG. 1, an objective lens 1 compatible with BD/DVD/CD for a thick type optical drive has a relatively large thickness (a distance along a horizontal direction in FIG. 1), and also has a relatively large size (a distance along a vertical direction in FIG. 1). The objective lens 1 respectively focuses three different wavelengths of light beams 2, 3, and 4 onto three different optical discs 5, 6, and 7. In this case, light beam 2 is approximately 780 nm and is used to record and/or reproduce data to and/or from optical disc 5 which is a CD, light beam 3 is approximately 650 nm and is used to record and/or reproduce data to and/or from optical disc 6 which is a DVD, and light beam 4 is approximately 405 nm and is used to record and/or reproduce data to and/or from optical disc 7 which is a BD. As shown in FIG. 1, the objective lens 1 has approximately the same focal length f (˜2-3 mm) for all three wavelengths of light beams 2, 3 and 4.

To increase the storage capacity of an optical disc, the spot sizes recorded onto encoding layers of the optical discs are decreased. As spot sizes decrease, the wavelength of the light used to detect the spot sizes correspondingly decreases, and the focusing powers (i.e., focusing angles), measured as a Numerical Aperture (NA), of the objective lens focusing the light increases. A CD is used with an objective lens having an NA of 0.45, a DVD is used with an objective lens having an NA of 0.65, and a BD is used with an objective lens having an NA of 0.85. Thus, the light beams 2, 3 and 4 are focused on the corresponding optical discs 5, 6 and 7 at increasingly sharper angles. Since the conventional single objective lens 1 is configured to have a relatively large thickness and size, the objective lens 1 can be configured to focus the light beams 2, 3 and 4 at the appropriate focusing angles, as shown in FIG. 1.

Also, the objective lens 1 for thick type disc drives compensates for spherical aberration. As shown in FIG. 2, different types of diffractive surfaces are used to eliminate the spherical aberration. For example, a separate optical element la to diffract light, such as a staircase lens, has been used. Alternatively, a surface 1b of the objective lens 1b has been configured to combine a staircase surface or Fresnel surface with a base refractive surface. These factors significantly eased the design flexibility for thick type drives.

However, “slim” disc drives, including, for example, slim-type (12.7 mm thickness), ultra-slim type (9.5 mm thickness) and super ultra slim type (7 mm thickness) disc drives, have presented technical problems that heretofore have not been solved. For example, in slim disc drives, the thickness of the disc drive, which is defined as the thickness along the direction of the axis of the objective lens, is limited. Furthermore, the size of the disc drive, which is defined as the length along a direction perpendicular to the axis of the objective lens, is also limited. As a result, the focal length of the objective lens is limited and the thickness of the objective lens itself is limited accordingly. Therefore, the conventional objective lens 1 shown in FIGS. 1 and 2 is incompatible with slim disc drives.

To satisfy both (1) the thickness restrictions for the shin type drives, and (2) the optical drive standards for numerical aperture (NA), which relates to the focusing angle, the focal length for BDs must be different from the focal length for DVDs and CDs. This is a geometrical restriction. Therefore, the BD/DVD/CD compatible objective lens for slim disc drives needs to be compatible with a very large focal length difference, in addition to compensating for spherical aberration and/or chromatic aberration. This is a new problem that to date has not been addressed by the industry.

### SUMMARY OF THE INVENTION

Aspects of certain embodiments of the present invention provide a single (monolithic) objective lens compatible with the three different wavelengths corresponding BD/DVD/CD and which is compatible with a slim blu-ray (BD) “combo” drive.

The objective lens according to aspects of certain embodiments of the present invention achieves dual focus control to focus light on BDs, DVDs, and CDs in a simple and effective manner.

The objective lens according to aspects of certain embodiments of the present invention further achieves a high diffraction efficiency for the diffracted light beams used to record and/or reproduce data to and/or from CDs and DVDs, and reproduce data from BDs.

The objective lens according to aspects of certain embodiments of the present invention further provides spherical and/or chromatic aberration correction.

The objective lens according to aspects of certain embodiments of the present invention also simplifies the configuration of slim type disc drives and reduces costs by using a single objective lens instead of multiple objective lenses.

The objective lens according to aspects of certain embodiments of the present invention also compensates for an off-axis light beam.

The objective lens according to aspects of certain embodiments of the present invention is also highly durable.

According to one aspect, there is provided an objective lens to focus a first light beam having a first wavelength onto a first optical disc, a second light beam having a second wavelength shorter than the first light beam onto a second optical disc, and a third light beam having a third wavelength shorter than the second light beam onto a third optical disc, the first, second and third light beams emitted from a light source, the objective lens comprising a first surface through which the first, second, and third light beams emitted from the light source enter the objective lens, the first surface including a first diffractive surface, and a second surface through which the first, second, and third light beams exit the objective lens and proceed toward the three corresponding optical discs, wherein the first diffractive surface provides focus position control in accordance with (i) 0th order light of the first and second light beams which are respectively focused onto the first and second optical discs, and (ii) 1st order diffracted light of the third light beam which is focused onto the third optical disc.

The objective lens may include a first diffractive surface comprising a first step height for the focus position control, wherein the first step height is in the range of 300-600 nm.

The objective lens may include a second surface comprising a second diffractive surface providing at least one of spherical aberration correction and chromatic aberration correction of at least one of the first, second and third light beams.

The objective lens may include a second diffractive surface comprising a staircase surface with a second step height for the spherical aberration correction and/or chromatic aberration correction, wherein the second step height provides diffraction of the first light beam and no diffraction of the second and third light beams.

The objective lens may include a second diffractive surface comprising a staircase surface with a third step height for the spherical aberration correction and/or chromatic aberration correction, wherein the third step height provides diffraction of the second light beam and no diffraction of the first and third light beams.

The objective lens may include a second diffractive surface comprising a staircase surface with a fourth step height for the spherical aberration correction and/or chromatic aberration correction, wherein the fourth step height provides diffraction of the third light beam and no diffraction of the first and second light beams.

The objective lens may include a second diffractive surface comprising a staircase surface with a fifth step height for the spherical aberration correction and/or chromatic aberration correction, wherein the fifth step height provides diffraction of the first and second light beams and no diffraction of the third light beam.

The objective lens may include a second diffractive surface comprising a staircase surface with a sixth step height for the spherical aberration correction and/or chromatic aberration correction, wherein the sixth step height provides diffraction of the second and third light beams and no diffraction of the first light beam.

The objective lens may include a second diffractive surface comprising a staircase surface with a seventh step height for the spherical aberration correction and/or chromatic aberration correction, wherein the seventh step height provides diffraction of the first and third light beams and no diffraction of the second light beam.

The objective lens may include a second step height t of the staircase surface such that m_{CD} is a non-integer and m_{DVD} and m_{BD} are exactly or approximately integers, where:

m_{CD}=t(n_{CD}−1)/λ_{CD}

m_{DVD}=t(n_{DVD}−1)/λ_{DVD}

m_{BD}=t(n_{BD}−1)/λ_{BD}

and λ_{CD}, λ_{DVD}, and λ_{BD} are the first wavelength, the second wavelength and the third wavelength, respectively and n_{CD}, n_{DVD}, and n_{BD} are refractive indices of material forming the objective lens for the wavelengths λ_{CD}, λ_{DVD}, and λ_{BD}, respectively.

The objective lens may include a third step height t of the staircase surface such that m_{DVD} is a non-integer and m_{CD} and m_{BD} are exactly or approximately integers.

The objective lens may include a fourth step height t of the staircase surface such that m_{BD} is a non-integer and m_{CD} and m_{DVD} are exactly or approximately integers.

The objective lens may include a fifth step height t of the staircase surface such that m_{CD} and m_{DVD} are non-integers and m_{BD} is exactly or approximately an integer.

The objective lens may include a sixth step height t of the staircase surface such that m_{DVD} and m_{BD} are non-integers and m_{CD} is exactly or approximately an integer.

The objective lens may include a seventh step height t of the staircase surface such that m_{CD} and m_{BD} are non-integers and m_{DVD} is exactly or approximately an integer.

The objective lens may include a second diffractive surface comprising a Fresnel surface with an eighth step height for the spherical aberration correction and/or chromatic aberration correction, wherein the eighth step height provides diffraction of the first, second and third light beams.

The objective lens may include an eighth step height t of the Fresnel surface such that m_{CD}, m_{DVD}, and m_{BD} are exactly or approximately integers.

The first wavelength may be approximately 780 nm, the first optical disc may be a CD, the second wavelength may be approximately 650 nm, the second optical disc may be a DVD, the third wavelength may be approximately 405 nm, and the third optical disc may be a BD.

The objective lens may include a lens formed from plastic.

The plastic may include at least one of ZEONEX 340-R or 350-R.

According to another aspect, there is provided an optical pickup comprising the above-described objective lens, a light source to generate the first, second and third light beams, and a detector to detect a signal corresponding to light reflected from any one of the first, second and third optical discs loaded.

According to another aspect, there is provided a disc drive comprising the above-described optical pickup, a power source device, a spindle motor to spin any one of the first, second and third optical discs loaded into the disc drive, and a main substrate which supplies power from the power source device to the spindle motor and the optical pickup.

The disc drive may be one of a slim-type disc drive comprising a thickness of approximately 12.7 mm, an ultra-slim type disc drive comprising a thickness of approximately 9.5 mm, and a super ultra slim type disc drive comprising a thickness of approximately 7 mm.

### BRIEF DESCRIPTION OF THE DRAWINGS

The accompanying drawings, which are incorporated in and constitute a part of the specification, illustrate presently preferred non-limiting examples of exemplary embodiments of the invention, and, together with the general description given above and the detailed description of the preferred embodiments given below, serve to explain the principles and concepts of the invention, in which like reference characters designate like or corresponding parts throughout the several drawings. Preferred embodiments of the present invention will now be further described in the following paragraphs of the specification and may be better understood when read in conjunction with the attached drawings, in which:

FIG. 1 depicts a conventional objective lens compatible with BD/DVD/CD for a thick type optical drive;

FIG. 2 depicts different types of diffractive surfaces used to eliminate spherical aberration for the conventional objective lens shown in FIG. 1;

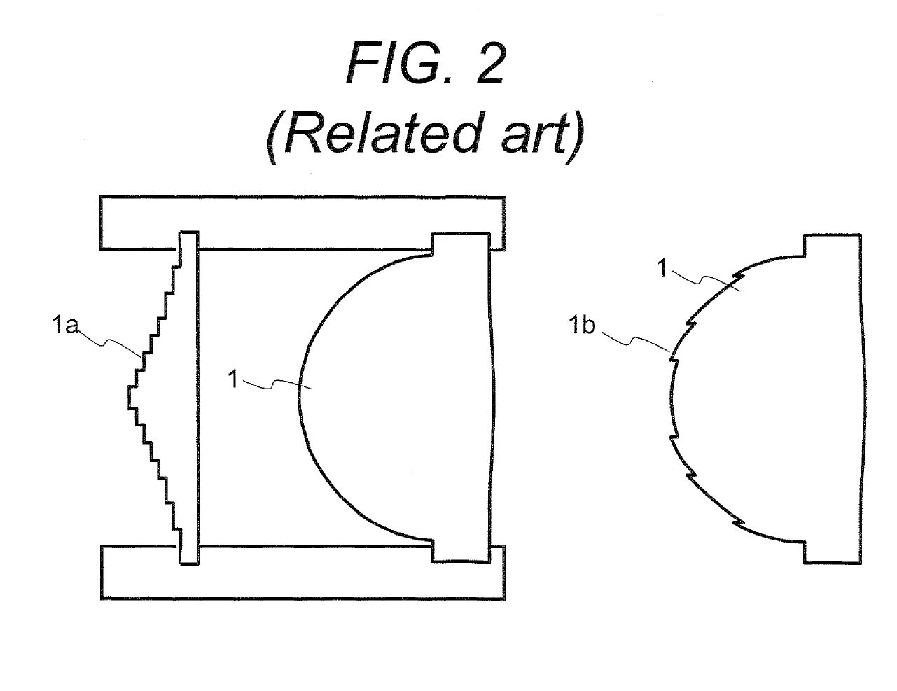

FIG. 3 depicts an objective lens according to an embodiment of the present invention;

FIG. 4 depicts step heights for a surface of an objective lens according to an embodiment of the present invention to achieve spherical aberration correction for the light beams employed to record and/or reproduce data to and/or from the CD and the DVD;

FIG. 5 is a comparison between the conventional objective lens shown in FIG. 1 and the objective lens according to an embodiment of the present invention shown in FIG. 3;

FIG. 6 shows a graph which illustrates step heights and corresponding diffraction efficiencies for 0^{th}, 1^{st}, and 2^{nd} order diffracted light beams used to record and/or reproduce data to and/or from BDs, DVDs, and CDs, according to an embodiment of the present invention;

FIG. 7 depicts a slim disc drive with an optical pickup having the objective lens according to an embodiment of the present invention; and

FIG. 8 depicts a diagram showing the difference in focusing angle between refraction and diffraction on the first surface of an objective lens.

### DETAILED DESCRIPTION OF THE INVENTION

Reference will now be made in detail to the presently non-limiting, exemplary and preferred embodiments of the invention as illustrated in the accompanying drawings. The nature, concepts, objectives and advantages of the present invention will become more apparent to those skilled in the art after considering the following detailed description in connection with the accompanying drawings. The following description is provided in order to explain preferred embodiments of the present invention, with the particular features and details shown therein being by way of non-limiting illustrative examples of various embodiments of the present invention. The particular features and details are presented with the goal of providing what is believed to be the most useful and readily understood description of the principles and conceptual versions of the present invention. In this regard, no attempt is made to show structural details of the invention in more detail than is necessary for the fundamental understanding of the present invention. The detailed description considered with the appended drawings are intended to make apparent to those skilled in the art how the several forms of the present invention may be embodied in practice.

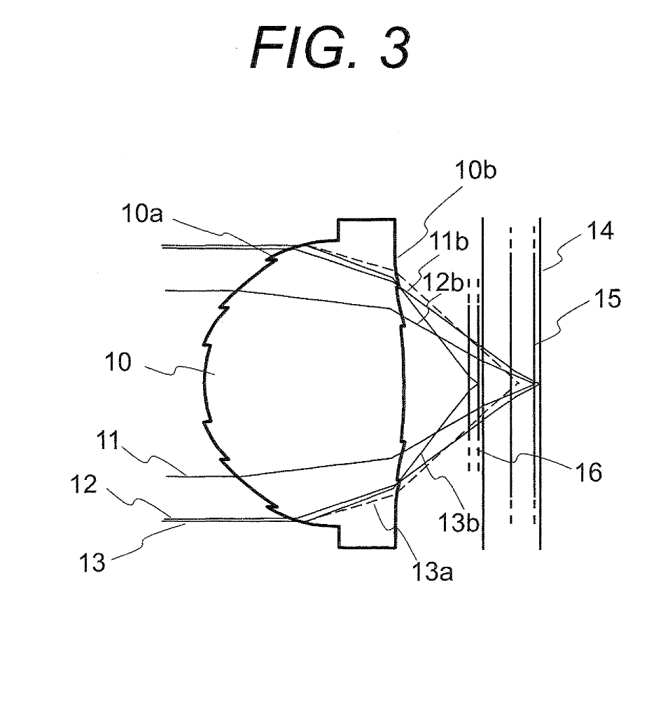

FIG. 3 depicts an objective lens 10 according to an embodiment of the present invention. The objective lens 10 is configured to be a single (monolithic) objective lens configured to focus three different wavelengths of light onto three different types of optical discs, for example, a CD, a DVD, and a blu-ray disc (BD). The objective lens 10 is configured to be used in “slim” BD combo disc drives, including, for example, slim-type (12.7 mm thickness), ultra-slim type (9.5 mm thickness) and super ultra slim type (7 mm thickness) disc drives, although lens 10 is not limited thereto. A combo drive typically refers to an optical disc drive configured to record and/or reproduce data to and/or from CD and DVD optical discs and reproduce data from BD optical discs. Panasonic™ has developed different types of combo drives, such as, for example, a 12.7 mm Slim Blu-Ray Combo Disc Drive configured to record and/or reproduce data to and/or from CDs and DVDs, and further configured to reproduce data from BDs. Combo drives are used in a wide variety of different electronic products, such as laptop computers, etc.

As shown in FIG. 3, the objective lens 10 respectively focuses three different wavelengths of light beams 11, 12, and 13 onto three different optical discs 14, 15, and 16. In FIG. 3, light beam 11 is approximately 780 nm and operates to record and/or reproduce data to and/or from optical disc 14 which is a CD, light beam 12 is approximately 650 nm and operates to record and/or reproduce data to and/or from optical disc 15 which is a DVD, and light beam 13 is approximately 405 nm and operates to reproduce data from optical disc 16 which is a BD. The CD, DVD, and BD shown in FIG. 3 may be various types, such as read-only, write-once, re-writable, etc. Additionally, the optical discs 14, 15 and 16 are not limited to being a CD, DVD, and BD, and instead may be various other types of optical discs. Furthermore, the light beams 11, 12, and 13 are not limited to being 780 nm, 650 nm and 405 nm, and may instead be other wavelengths. Each of the optical discs 14, 15 and 16 has a flat encoding surface on which data may be recorded and/or reproduced on and/or from, and a cover layer which protects the encoding surface from dust and other particles. Optical discs are well known in the art and a detailed discussion thereof is omitted.

The objective lens 10 may be made of a plastic material. For example, the objective lens 10 may be made of a plastic known as ZEONEX™ brand plastic, such as ZEONEX 340-R or ZEONEX 350-R, or any related products, such as any products in the ZEONEX 3xx series, produced by Zeon Chemicals L.P. By forming the objective lens 10 out of a plastic material, the objective lens 10 can be produced in an economical fashion. ZEONEX 3xx series plastic lenses are a very durable solution and demonstrate superior durability with blue laser light. It is understood, however, that various other types of materials, including plastics and non-plastic materials (e.g., glass) may alternatively be used to form the objective lens 10.

The objective lens 10 is further configured to compensate for or tolerate an off-axis light beam. An off-axis light beam occurs when an objective lens follows the disc tilt. To compensate for an off-axis light beam, the objective lens should be configured so that there is the same or a close amount of COMA aberration as the amount yielded by the disc tilt alone when the objective lens 10 tilts to +/−0.5 degrees. When the objective lens and the disc tilt together, the COMA aberration can be cancelled. To satisfy this condition of little to no COMA aberration, the objective lens should be configured to satisfy Abbe's sine condition in the presence of disc tilt. If a lens satisfies Abbe's sine condition with disc tilt, the optical system yields no COMA aberration at a certain disc tilt.

Therefore, according to an aspect of certain embodiments of the present invention, the objective lens 10 is configured to satisfy Abbe's sine condition. Specifically, the objective lens 10 is configured to have a diffractive surface (e.g., a staircase or Fresnel surface) on the first surface. As a result of this configuration, a diffracted light beam which is used to record and/or reproduce data from the BD 16 (e.g., a 1^{st} order diffracted light beam 13b), diffracted by a diffractive surface (e.g., a staircase or Fresnel surface) of the first surface 10a of the objective lens 10, satisfies the sine condition. Furthermore, non-diffracted light beams which are used to record and/or reproduce data to and/or from the CD 14 and DVD 15 (e.g., 0^{th} order light beams 11 and 12), also satisfy the sine condition. Therefore, in addition to achieving numerous other benefits, including providing a single (monolithic) objective lens compatible with a slim blu-ray (BD) “combo” drive, the objective lens 10 according to an aspect of certain embodiments of the present invention additionally is configured to compensate for an off-axis light beam.

As shown in FIG. 3, the objective lens 10 includes a first surface 10a which initially receives light beams 11, 12 and 13 emitted from a light source, such as a conventional laser diode or a plurality of laser diodes. The first surface 10a is configured to function as a diffractive surface for dual focus so that the light beams 11, 12 and 13 are focused on the encoding surfaces of the corresponding CD 14, DVD 15 and BD 16. According to aspects of certain embodiments of the present invention, the first surface 10a may be configured as a staircase surface or a Fresnel surface on an aspheric base shape, although the embodiment is not limited to such configuration. The step height for the first surface 10a is in the range of approximately 0.3 μm to approximately 0.6 μm. Thus, the step height for the first surface 10a is configured to be small enough to diffract the light beam 13 without diffracting the light beams 11 and 12.

Consequently, the first surface 10a diffracts the light beam 13 into at least a 0^{th} order light beam 13a and a 1^{st} order diffracted light beam 13b. The 1^{st} order diffracted light beam 13b is employed to reproduce data from an encoding surface of the BD 16. The 0^{th} order light beam 13a is not employed.

Furthermore, the first surface 10a diffracts the light beams 11 and 12 into at least 0^{th} order light beams 11b and 12b and 1^{st} order diffracted light beams (not shown). The 0^{th} order light beams 11b and 12b are employed to record and/or reproduce data to and/or from an encoding surface of the CD 14 and DVD 15. The 1^{st} order light beams are not employed. The 0^{th} order light beam 11 is focused on the encoding surface of the CD 14, and the 0^{th} order light beam 12 is focused on the encoding surface DVD 15. Consequently, the light beams 11 and 12 achieve a high diffraction efficiency, for the CD 14 and the DVD 15, of approximately 70% or more provided the step height of the diffractive surface is less than 0.6 μm. The 1^{st} order diffraction light beam 13b achieves a diffraction efficiency of approximately 40% or more for the BD 16 provided the step height of the diffractive surface is less than 0.6 μm. Furthermore, since the 1^{st} order diffracted light beam 13b focuses on the encoding surface of the BD 16, the objective lens 10 achieves a large focal length difference at a small drop of diffraction efficiency.

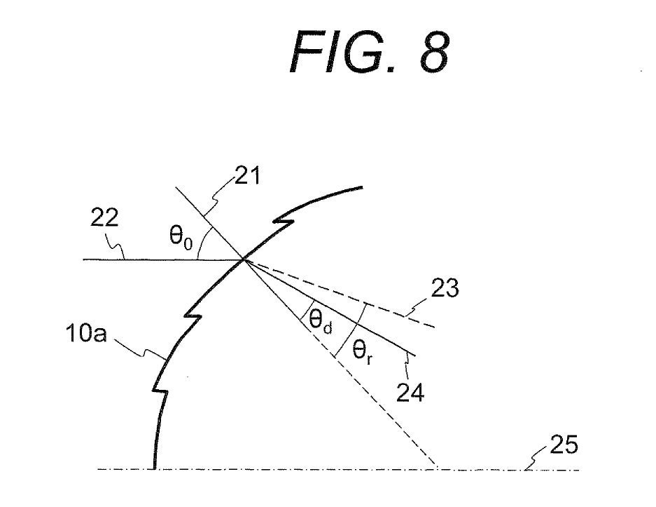

Referring to FIG. 8, the refraction angle θᵣ of the 0^{th} order, i.e., non-diffracted light beam 23 with respect to the incident angle θ₀ can be calculated from the Snell's law

sin θᵣ=sin θ₀/n, (1)

where θ₀ and n are the incident angle of the beam with respect to the normal 21 of the local surface and the refractive index of the lens material as a function of the wavelength, giving almost the same refraction angle for the light beam 11 and light beam 12 as the refractive indices are almost the same. On the other hand, the diffraction angle θ_{d} of the m^{th} order diffracted light beam 24 can be calculated using the diffraction grating equation

sin θ_{d}=sin θ₀/n−mλ/(np), (2)

where m, λ and p are an integer representing the diffraction order, the wavelength and the local period of the diffractive surface, respectively. Comparing Equation (1) and Equation (2), the second term in Equation (2) for the diffracted angle makes a difference from the refraction angle, which yields corresponding focus position shift.

Thus the difference in the beam angle is mλ/(np) for 0^{th} order beams and m^{th} order beams, where m can be any integer number as far as the diffraction efficiency of the m^{th} order meets the requirement for the optical drive.

Moreover, referring to FIG. 3, although the light beam 13 is split into a 0^{th} order light beam 13a and a 1^{st} order diffracted light beam 13b, which results in a certain loss of efficiency, this efficiency loss is tolerable, as only a small amount of power is needed to reproduce data from the BD 16. Furthermore, the light beam 13 is not limited to reproducing data from the BD 16 depending on factors such as the strength of the laser diode used to generate the light beam 13.

As shown in FIG. 3, the objective lens 10 further includes a second surface 10b through which the light beams 11, 12 and 13 exit and proceed towards the corresponding optical discs 14, 15 and 16. Generally, objective lenses may suffer from spherical aberration and/or chromatic aberration. Spherical aberration refers to a failure of a lens to correctly focus light beams striking a lens near its edge at the same convergence point as light beams striking the lens in the center, due to increased refraction of the light beams striking the edge of the lens. Chromatic aberration refers to a failure of a lens to correctly focus light beams having different wavelengths (i.e., colors) at the same convergence point, due to the light beams with different wavelengths having different corresponding refractive indices and dispersion. Accordingly, the second surface 10b of the objective lens 10 is configured to correct spherical aberration, chromatic aberration, or a combination of spherical aberration and chromatic aberration.

To correct spherical aberration and/or chromatic aberration, according to aspects of certain embodiments of the present invention, the second surface 10b of the objective lens 10 is configured as a diffractive surface having a staircase shape or a Fresnel surface on an aspheric base shape, the diffractive surface being formed of steps or blazes, and each step having a step height, although the embodiment is not limited to such configuration. The staircase surface (or Fresnel surface) diffracts incoming light into different orders of light, e.g., 0^{th} order light, 1^{st} order light, and so on. According to an aspect of a certain embodiment of the present invention, the objective lens 10 may be configured to be optimized for DVD and BD for example, so spherical aberration correction and/or chromatic aberration is required only for CD, i.e., the light beams 11. Accordingly, a step height chosen for the second surface 10b to correct spherical aberration or chromatic aberration is calculated to diffract the light beams 11 which operate to record and/or reproduce data to and/or from the CD 14 into 0^{th} and higher order light beams, without diffracting the light beams 12 and 13 operating to record and/or reproduce data to and/or from the DVD 15 and reproduce data from the BD 16.

According to an aspect of a certain embodiment of the present invention, the objective lens 10 may be configured to be optimized for CD and BD, so spherical aberration correction and/or chromatic aberration is required only for the light beams 12. Accordingly, a step height chosen for the second surface 10b to correct spherical aberration or chromatic aberration is calculated to diffract the light beams 12 which operate to record and/or reproduce data to and/or from the DVD 15 into 0^{th} and higher order light beams, without diffracting the light beam 11 and 13 operating to record and/or reproduce data to and/or from the CD 14 and reproduce data from the BD 16, respectively.

According to an aspect of a certain embodiment of the present invention, the objective lens 10 may be configured to be optimized for CD and DVD, so spherical aberration correction and/or chromatic aberration is required only for the light beams 13. Accordingly, a step height chosen for the second surface 10b to correct spherical aberration or chromatic aberration is calculated to diffract the light beams 13 which operate to reproduce data from the BD 16 into 0^{th} and higher order light beams, without diffracting the light beam 11 and 12 operating to record and/or reproduce data to and/or from the CD 14 and DVD 15.

According to an aspect of a certain embodiment of the present invention, the objective lens 10 may be configured to be optimized for BD, so spherical aberration correction and/or chromatic aberration is required only for the light beams 11 and 12. Accordingly, a step height chosen for the second surface 10b to correct spherical aberration or chromatic aberration is calculated to diffract the light beams 11 and 12 which operate to record and/or reproduce data to and/or from the CD 14 and to record and/or reproduce data from the DVD 15 into 0^{th} and higher order light beams, without diffracting the light beam 13 operating to reproduce data from the BD 16.

According to an aspect of a certain embodiment of the present invention, the objective lens 10 may be configured to be optimized for CD, so spherical aberration correction and/or chromatic aberration is required only for the light beams 12 and 13. Accordingly, a step height chosen for the second surface 10b to correct spherical aberration or chromatic aberration is calculated to diffract the light beams 12 and 13 which operate to record and/or reproduce data to and/or from the DVD 15 and to reproduce data from the BD 16 into 0^{th} and higher order light beams, without diffracting the light beam 11 operating to record and/or reproduce data to and/or from the CD 14.

According to an aspect of a certain embodiment of the present invention, the objective lens 10 may be configured to be optimized for DVD, so spherical aberration correction and/or chromatic aberration is required only for the light beams 11 and 13. Accordingly, a step height chosen for the second surface 10b to correct spherical aberration or chromatic aberration is calculated to diffract the light beams 11 and 13 which operate to record and/or reproduce data to and/or from the CD 14 and to reproduce data from the BD 16 into 0^{th} and higher order light beams, without diffracting the light beam 12 operating to reproduce data from the DVD 15.

According to an aspect of another embodiment of the present invention, the objective lens 10 may be configured to compensate spherical aberration and/or chromatic aberration correction for all light beams 11, 12 and 13. Accordingly, a step height chosen for the second surface 10b to correct spherical aberration and/or chromatic aberration is calculated to diffract all the light beams 11, 12 and 13 which operate to record and/or reproduce data to and/or from the CD 14 and DVD 15 and to reproduce data from the BD.

To achieve spherical aberration correction and/or chromatic aberration correction, the step height t of the second diffractive staircase surface is a height such that m_{CD} is a non-integer and m_{DVD} and m_{BD} are exactly or approximately an integer, or m_{DVD} is a non-integer and m_{CD} and m_{BD} are exactly or approximately an integer, or m_{BD} is a non-integer and m_{CD} and m_{DVD} are exactly or approximately an integer, or m_{CD} and m_{DVD} are non-integers and m_{BD} is exactly or approximately an integer, or m_{DVD} and m_{BD} are non-integers and m_{CD} is exactly or approximately an integer, or m_{CD} and m_{BD} are non-integers and m_{DVD} is exactly or approximately an integer, or m_{CD}, m_{DVD}, m_{BD} are all exactly or approximately integers, where:

m_{CD}=t(n_{CD}−1)/λ_{CD}

m_{DVD}=t(n_{DVD}−1)/λ_{DVD}

m_{BD}=t(n_{BD}−1)/λ_{BD}

and λ_{CD}, λ_{DVD}, and λ_{BD} are the wavelength of CD (e.g., approximately 780 nm), the wavelength of DVD (e.g., approximately 650 nm), and the wavelength of BD (e.g., approximately 405 nm), and n_{CD}, n_{DVD}, and n_{BD} are the refractive indices of material forming the objective lens for the wavelengths of CD, DVD, and BD, respectively. If the objective lens 10 is formed from the ZEONEX 340-R or 350-R or similar ZEONEX series plastic material, the refractive index n_{CD}, n_{DVD}, and n_{BD} are the refractive indices of the ZEONEX plastic for CD, DVD, and BD, which are 1.52, 1.51, and 1.51, respectively. The numbers m_{BD}, m_{DVD}, m_{BD} may be chosen as set forth in Table 1.

TABLE 1
Examples of m_{CD}, m_{DVD}, m_{BD}

| Example # | Step height (um) | m_{CD} | m_{DVD} | m_{BD} |
|---|---|---|---|---|
| 1 | 6.35 | 4.2 | 5 | 8 |
| 2 | 13.5 | 9 | 10.6 | 17 |
| 3 | 25.5 | 17 | 20 | 32.1 |
| 4 | 3 | 2 | 2.4 | 3.8 |
| 5 | 1.3 | 0.9 | 1 | 1.6 |
| 6 | 0.8 | 0.5 | 0.6 | 1 |

Consequently, the spherical aberration and/or chromatic aberration affecting the light beams 11, 12 and 13 that record and/or reproduce data to and/or from the CD 14 and DVD 15 and reproduce from the BD 16 is selectively corrected.

It is understood that spherical and/or chromatic aberration is not limited to being corrected by the second surface 10b, and may instead be corrected by the first surface 10a or other optical elements, such as a separate optical element.

Thus, as shown in FIG. 3, an objective lens 10 configured to have a first surface 10a to achieve dual focus and a second surface 10b to correct spherical aberration and/or chromatic aberration enables a slim disc drive with the following beneficial characteristics to be achieved. The objective lens 10 possesses the ability to compensate for or tolerate an off-axis light beam.

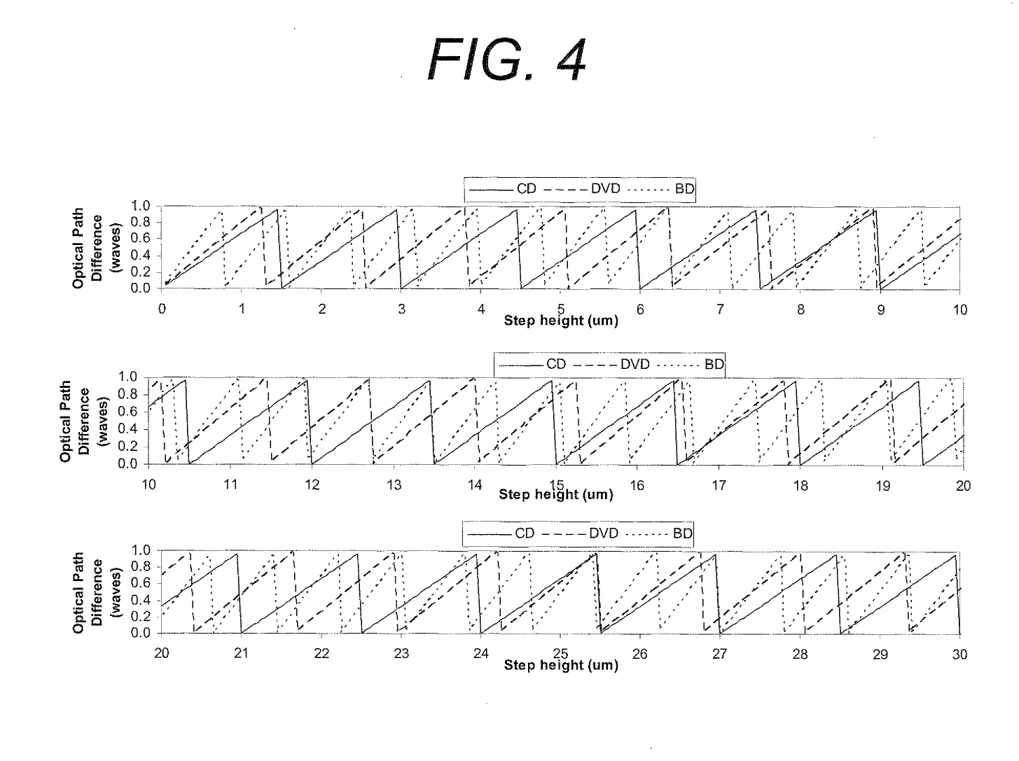

FIG. 4 depicts step heights for the second surface 10b to achieve spherical aberration correction and/or chromatic aberration correction for the light beams 11, 12, and 13 employed to record and/or reproduce data to and/or from the CD 14 and the DVD 15 and to reproduce data from the BD 16. In FIG. 4, the x-axis represents a selected step height (μm) and the y-axis represents an optical path difference (waves). For example, if the step height of the second surface 10b is selected to be 3.0 μm, the optical path difference for the light beam 11 used with CD 14 is 0 and for the light beam 12 and 0.4 waves for the light beam 12 used with DVD 15 and 0.8 waves for the light beam 13 used with the BD 16 when the objective lens 10 is formed from a ZEONEX™ brand plastic. It is understood, however, that this is merely one embodiment of this invention and the objective lens 10 is not limited to being formed from a ZEONEX™ brand plastic, and the step heights are not limited to those shown in FIG. 4.

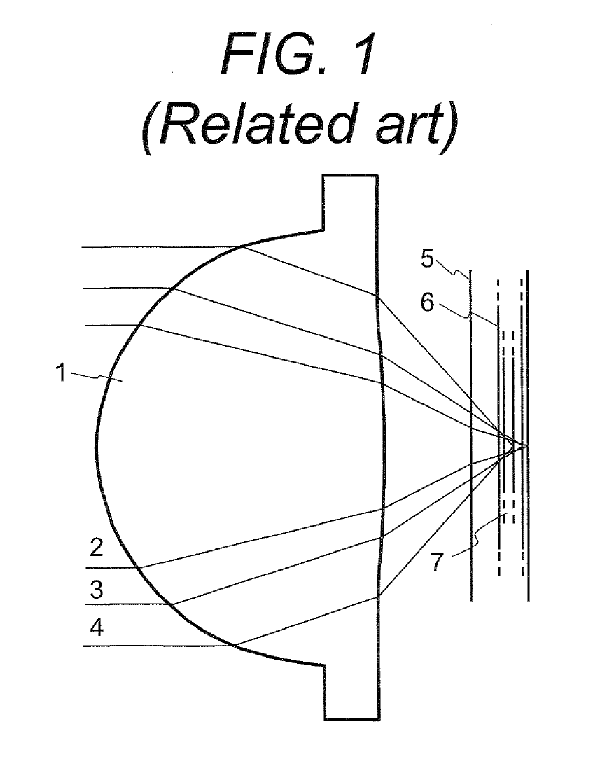

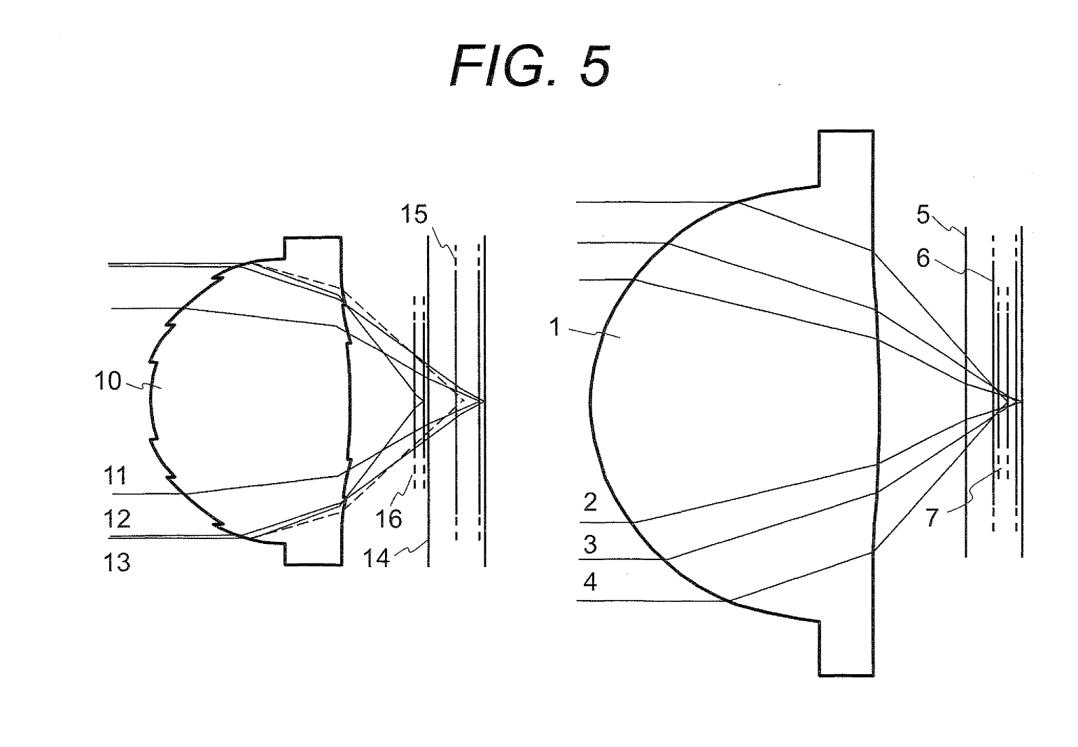

FIG. 5 depicts a comparison between the conventional objective lens shown in FIG. 1 and the objective lens according to an embodiment of the present invention shown in FIG. 3. As shown in FIG. 5, the objective lens 10 has a smaller thickness (a distance in a horizontal direction) and size (a distance in the vertical direction) than the conventional objective lens 1. The objective lens 10 also achieves a substantially larger focal length difference between the 1^{st} order diffracted light beam 13b and the 0^{th} order light beams 11 and 12 as compared to the focal length difference achieved by the conventional objective lens 1. Thus, the objective lens 10 is ideally configured to be used with optical pickups found in slim disc drives.

Also, although the objective lens 10 (FIG. 3) is shown and described as being configured to focus three different wavelengths of light, it is understood that objective lenses according to other aspects of certain embodiments of the present invention may be employed with more or less than three wavelengths of light and three optical discs. For example, the objective lens 10 may be used with a combo drive that works with two types of optical discs instead of three, such as a combo drive compatible with CDs and BDs or DVDs and BDs. Furthermore, the objective lens 10 is not limited to embodiments being used with CDs, DVDs, and BDs, and may instead be used with various other types of optical disc formats.

In FIG. 5, the arrangement of the CD 5, DVD 6, and BD 7 used in connection with the conventional objective lens 1 differs from the arrangement of the CD 14, DVD 15, and BD 16 used with the objective lens 10. Conventionally, the encoding layer of the BD 7 is positioned relatively farther back from the conventional objective lens 1 and relatively closer to the encoding layers of the CD 5 and the DVD 6, as compared to the positioning of the BD 16. This is because the conventional objective lens 1 has a greater thickness and size than the objective lens 10, and thus can achieve the required focusing angle required for BDs (NA=0.85) from a farther distance, if the 0^{th} order diffracted light beam of light beam 4 is used. However, slim drives have limitations on the thickness and size available for the objective lens, and thus, the conventional objective lens 1 is unable to achieve the required focusing angle required for BDs in a slim drive. In contrast, as shown in FIG. 5, the objective lens 10 according to an embodiment of the present invention has a configuration that achieves the required focusing angle for BDs in a slim drive.

In an embodiment of the present invention, the refracted beam angles θ_{r, CD} and θ_{r, DVD} for 0^{th} order non-diffracted light beams used to record and/or reproduce data to and/or from CDs and DVDs are given by

sin θ_{r, CD}=sin θ₀/n_{CD}, (3)

and

sin θ_{r, DVD}=sin θ₀/n_{DVD}, (4)

where n_{CD} and n_{DVD} are the refractive index of the disc material for CDs and DVDs, respectively, while the beam angle θ_{d, BD} for a 1^{st} order diffracted light beam used to reproduce data from BDs is given by

sin θ_{d, BD}=sin θ₀/n_{BD}−λ/(n_{BD}p), (5)

where n_{BD} is the refractive index of the disc material for BDs. Thus a large focus position shift between CD/DVD and BD corresponding to the difference in beam angle can be obtained. Thus, the objective lens 10 is configured to achieve dual focus in a slim drive.

On the other hand, the refracted beam angles θ_{r, CD}, θ_{r, DVD} and θ_{r, BD} in the prior art for 0^{th} order non-diffracted light beams for CDs, DVDs and BDs are given by

sin θ_{r, CD}=sin θ₀/n_{CD}, (6)

sin θ_{r, DVD}=sin θ₀/n_{DVD}, (7)

and

sin θ_{r, BD}=sin θ₀/n_{BD}, (8)

making almost no difference in the refraction angle for all wavelengths since the refractive indices are almost the same, e.g., 1.51, 1.51 and 1.52 for CDs, DVDs, and BDs, respectively for ZEONEX 3xx series. Accordingly there is almost no difference in focus position between CDs, DVDs, and BDs, which leads to the problem that the objective lens tends to be large.

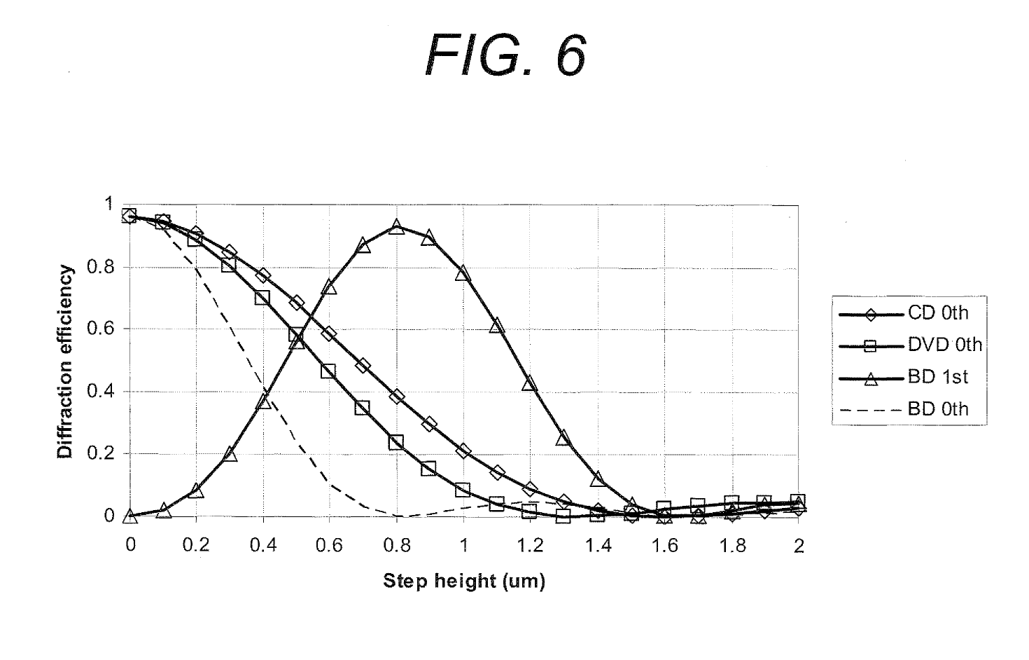

FIG. 6 shows a graph which illustrates step heights and corresponding diffraction efficiencies, for 0^{th} and 1^{st} order diffracted light beams used to record and/or reproduce data to and/or from CDs and DVDs, and to reproduce data from BDs, according to an embodiment of the present invention. In FIG. 6, the x-axis represents a step height (measured in μm increasing from left to right) of an objective lens surface, such as the first surface 10a of the objective lens 10 shown in FIG. 3. The y-axis represents the diffraction efficiency of diffracted light beams, such as the 0^{th}, and 1^{st} order diffracted light beams of light beams 11 (CD), 12 (DVD) and 13 (BD) shown in FIG. 3.

As shown in FIG. 6, the objective lens surface 10a according to an aspect of certain embodiments of the present invention has a step height ranging from approximately 0.3 μm to approximately 0.6 μm.

Due to the configuration of a step height in the range of approximately 0.3 μm to 0.6 μm, the objective lens 10 achieves a greater focal length difference between the 0^{th} order light beam and 1^{st} order diffracted light beam of the light beam 13 used with the BD 16.

Also, due to the configuration of a step height in the range of approximately 0.3 μm to approximately 0.6 μm, the objective lens 10 achieves a diffraction efficiency sufficient for a BD combo drive. As shown in the y-axis, the 0^{th} order light beams for the light beams 11 and 12 in the step height range of approximately 0.3 μm to approximately 0.6 μm have relatively high diffraction efficiencies and therefore are powerful enough to both record and reproduce data to and from the CD 14 and the DVD 15. Also, the 1^{st} order diffracted light beam for the light beam 13 in the step height range of approximately 0.3 μm to approximately 0.6 μm is sufficiently powerful to reproduce data from the BD 16, and may also be sufficiently powerful to record data to the BD 16 depending on the type of BD 16, the power of the laser diode, and so on.

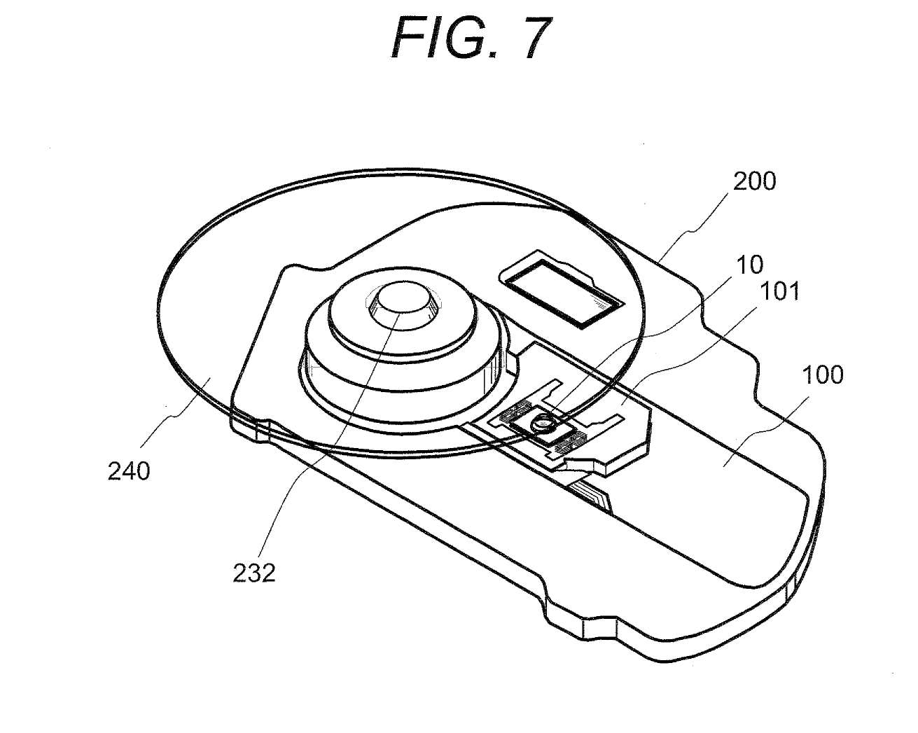

FIG. 7 depicts a slim disc drive with an optical pickup having the objective lens according to an embodiment of the present invention. As shown in FIG. 7, the slim disc drive 200 includes an optical pickup 101, and the optical pickup 101 includes the objective lens 10 shown in FIG. 3.

The optical pickup 101 includes a light source (not shown), which includes, for example, a laser diode or a plurality of laser diodes, to generate laser light beams for recording and/or reproduction of data to and/or from the optical disc 240. Also, the optical pickup 101 includes a detector (not shown) to detect a signal corresponding to light reflected from the optical disc 240 loaded into the disc drive 200. The optical pickup 101 is supported by a stepping motor, DC motor, or other motor (not shown) so as to be movable. Thus, the optical pickup 101 is configured to perform a traverse operation along a radial direction of the optical disk 240. With this traverse operation, the optical pickup 101 accesses a target track on the optical disk 240. The optical disk 240 can be, for example, a CD, a DVD, or a BD.

The disc drive 200 further includes a power source device (not shown), a spindle motor 232 to spin the optical disk 240, and a main substrate 100 which supplies power from the power source device to devices such as the spindle motor 232 and the optical pickup 101 so as to enable transmission/reception of electrical signals between these devices. Although not shown in the figure, various integrated circuit elements to be used for signal processing may be mounted on the main substrate 100.

The objective lens 10 functions as described above to record and/or reproduce data to and/or from CDs and DVDs, and to reproduce data from BDs in the slim disc drive 200. The slim disc drive 200 may be various types and thicknesses, including, for example, slim-type (12.7 mm thickness), ultra-slim type (9.5 mm thickness) and super ultra slim type (7 mm thickness) disc drives. It is understood that the slim disc drive may also be configured to have other thicknesses and layouts different from the layout shown in FIG. 7.

The foregoing description illustrates and describes embodiments of the present invention. However, the disclosure shows and describes only the preferred embodiments of the invention, but it is to be understood that the invention is capable of use in various other combinations, modifications, and environments. Also, the invention is capable of change or modification, within the scope of the inventive concept, as expressed herein, that is commensurate with the above teachings and the skill or knowledge of one skilled in the relevant art. For example, one or more elements of each embodiment may be omitted or incorporated into the other embodiments.

The foregoing implementations and embodiments of the invention have been presented for purposes of non-limiting illustration and description. Although the present invention has been described herein with reference to particular structures, materials and embodiments, the present invention is not intended to be limited to the particular features and details disclosed herein. Rather, the present invention extends to all functionally equivalent structures, methods and uses, such as are within the scope of the appended claims. The descriptions provided herein are not exhaustive and do not limit the invention to the precise forms disclosed. The foregoing embodiment examples have been provided merely for purposes of explanation and are in no way to be construed as limiting the scope of the present invention. The words that have been used herein are words of description and illustration, rather than words of limitation. The present teachings can readily be realized and applied to other types of apparatuses. Further, modifications and variations, within the purview, scope and spirit of the appended claims and their equivalents, as presently stated and as amended hereafter, are possible in light of the above teachings or may be acquired from practicing the invention. Furthermore, although elements of the invention may be described or claimed in the singular, the plural is contemplated unless limitation to the singular is explicitly stated. Alternative structures discussed for the purpose of highlighting the invention's advantages do not constitute prior art unless expressly so identified. No one or more features of the present invention are necessary or critical unless otherwise specified.

What is claimed is:

1. An objective lens to focus a first light beam having a first wavelength onto a first optical disc, a second light beam having a second wavelength shorter than the first light beam onto a second optical disc, and a third light beam having a third wavelength shorter than the second light beam onto a third optical disc, the first, second and third light beams emitted from a light source, the objective lens comprising:
a first surface through which the first, second, and third light beams emitted from the light source enter the objective lens, the first surface including a first diffractive surface; and
a second surface through which the first, second, and third light beams exit the objective lens and proceed toward the three corresponding optical discs,
wherein the first diffractive surface provides focus control in accordance with (i) 0th order light of the first and second light beams which are respectively focused onto the first and second optical discs, and (ii) 1st order diffracted light of the third light beam which is focused onto the third optical disc.

2. The objective lens of claim 1, wherein the first diffractive surface comprises a first step height providing diffraction efficiency control for the first, second, and third light beams.

3. The objective lens of claim 1, wherein a first step height of the first diffractive surface is in the range of 300 nm-600 nm.

4. The objective lens of claim 1, wherein the second surface comprises a second diffractive surface providing at least one of chromatic aberration correction and spherical aberration correction by providing diffraction of at least one or two of the first, second, and third light beams and no diffraction of the rest of the light beams.

5. The objective lens of claim 4, wherein the second diffractive surface is a staircase surface.

6. The objective lens of claim 5, wherein the staircase surface comprises a second step height providing diffraction of the first light beam and no diffraction of the second and third light beams.

7. The objective lens of claim 5, wherein the staircase surface comprises a third step height providing diffraction of the second light beam and no diffraction of the first and third light beams.

8. The objective lens of claim 5, wherein the staircase surface comprises a fourth step height providing diffraction of the third light beam and no diffraction of the first and second light beams.

9. The objective lens of claim 5, wherein the staircase surface comprises a fifth step height providing diffraction of the first and second light beams and no diffraction of the third light beam.

10. The objective lens of claim 5, wherein the staircase surface comprises a sixth step height providing diffraction of the second and third light beams and no diffraction of the first light beam.

11. The objective lens of claim 5, wherein the staircase surface comprises a seventh step height providing diffraction of the first and third light beams and no diffraction of the second light beam.

12. The objective lens of claim 6, wherein the second step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the second step height, and m_{CD} is a non-integer and m_{DVD} and m_{BD} are exactly or approximately integers, λ_{CD}, λ_{DVD}, and λ_{BD} are the first wavelength, the second wavelength and the third wavelength, respectively, and n_{CD}, n_{DVD}, and n_{BD} are refractive indices of material forming the objective lens for the wavelengths λ_{CD}, λ_{DVD}, and λ_{BD}, respectively.

13. The objective lens of claim 7, wherein the third step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the third step height, and m_{DVD} is a non-integer and m_{CD} and m_{BD} are exactly or approximately integers, λ_{CD}, λ_{DVD}, and λ_{BD} are the first wavelength, the second wavelength and the third wavelength, respectively, and n_{CD}, n_{DVD}, and n_{BD} are refractive indices of material forming the objective lens for the wavelengths λ_{CD}, λ_{DVD}, and λ_{BD}, respectively.

14. The objective lens of claim 8, wherein the fourth step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the fourth step height, and m_{BD} is a non-integer and m_{CD} and m_{DVD} are exactly or approximately integers, λ_{CD}, λ_{DVD}, and λ_{BD} are the first wavelength, the second wavelength and the third wavelength, respectively, and n_{CD}, n_{DVD}, and n_{BD} are refractive indices of material forming the objective lens for the wavelengths λ_{CD}, λ_{DVD}, and λ_{BD}, respectively.

15. The objective lens of claim 9, wherein the fifth step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the fifth step height, and m_{CD} and m_{DVD} are non-integers and m_{BD} is exactly or approximately an integer, λ_{CD}, λ_{DVD}, and λ_{BD} are the first wavelength, the second wavelength and the third wavelength, respectively, and n_{CD}, n_{DVD}, and n_{BD} are refractive indices of material forming the objective lens for the wavelengths λ_{CD}, λ_{DVD}, and λ_{BD}, respectively.

16. The objective lens of claim 10, wherein the sixth step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the sixth step height, m_{DVD} and m_{BD} are non-integers and m_{CD} is exactly or approximately an integer, λ_{CD}, λ_{DVD}, and λ_{BD} are the first wavelength, the second wavelength and the third wavelength, respectively, and n_{CD}, n_{DVD}, and n_{BD} are refractive indices of material forming the objective lens for the wavelengths λ_{CD}, λ_{DVD}, and λ_{BD}, respectively.

17. The objective lens of claim 11, wherein the seventh step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the seventh step height, m_{CD} and m_{BD} are non-integers and m_{DVD} is exactly or approximately an integer, λ_{CD}, λ_{DVD}, and λ_{BD} are the first wavelength, the second wavelength and the third wavelength, respectively, and n_{CD}, n_{DVD}, n_{BD} are refractive indices of material forming the objective lens for the wavelengths λ_{CD}, λ_{DVD}, and λ_{BD}, respectively.

18. The objective lens of claim 4, wherein the second diffractive surface is a Fresnel surface.

19. The objective lens of claim 18, wherein the Fresnel surface comprises an eighth step height providing diffraction of the first, second and third light beams.

20. The objective lens of claim 19, wherein the eighth step height is chosen according to the formula:
m_{CD}=t(n_{CD}−1)/λ_{CD},
m_{DVD}=t(n_{DVD}−1)/λ_{DVD},
m_{BD}=t(n_{BD}−1)/λ_{BD},
where t is the eighth step height, m_{CD}, m_{DVD}, and m_{BD} are exactly or approximately integers, λ_{CD}, λ_{DVD}, and λ_{BD} are the first wavelength, the second wavelength and the third wavelength, respectively, and n_{CD}, n_{DVD}, and n_{BD} are refractive indices of material forming the objective lens for the wavelengths λ_{CD}, λ_{DVD}, and λ_{BD}, respectively.

21. The objective lens of claim 1, wherein the first wavelength is approximately 780 nm, the first optical disc is a CD, the second wavelength is approximately 650 nm, the second optical disc is a DVD, the third wavelength is approximately 405 nm, and the third optical disc is a BD.

22. The objective lens of claim 1, wherein the lens is formed from plastic.

23. The objective lens of claim 22, wherein the plastic comprises at least one of ZEONEX 340-R or 350-R.

24. An optical pickup, comprising:
an objective lens according to claim 1;
a light source to generate said first, second and third light beams; and
a detector to detect a signal corresponding to light reflected from any one of said first, second and third optical discs loaded.

25. A disc drive, comprising:
an optical pickup according to claim 24;
a power source device;
a spindle motor to spin any one of said first, second and third optical discs loaded into the disc drive; and
a main substrate which supplies power from the power source device to the spindle motor and the optical pickup.

26. The disc drive of claim 25, wherein the disc drive is one of a slim-type disc drive comprising a thickness of approximately 12.7 mm, an ultra-slim type disc drive comprising a thickness of approximately 9.5 mm, and a super ultra slim type disc drive comprising a thickness of approximately 7 mm.

27. An objective lens to focus a first light beam having a first wavelength onto a first optical disc and a second light beam having a second wavelength shorter than the first light beam onto a second optical disc, the first and second light beams emitted from a light source, the objective lens comprising:
a first surface through which the first and second light beams emitted from the light source enter the objective lens, the first surface including a diffractive surface; and
a second surface through which the first and second light beams exit the objective lens and proceed toward the two corresponding optical discs,
wherein the diffractive surface provides focus control in accordance with (i) 0^{th} order light of the first light beam which is focused onto the first optical disc, and (ii) 1^{st} order diffracted light of the second light beam which is focused onto the second optical disc.

28. The objective lens of claim 27, wherein the first optical disc is one of a CD and a DVD, the second optical disc is a BD, and a step height of the diffractive surface is in the range of approximately 300 nm to approximately 600 nm.
